(19) United States
(12) Patent Application Publication
(10) Pub. No.: US 2010/0031228 A1
(43) Pub. Date: Feb. 4, 2010

(54) Process for testing models

(75) Inventors: Marco Rohe, Herscheid (DE); Uwe Finis, Neuenrade (DE); Nino Hoener, Werdohl (DE)

Correspondence Address: Davidson, Davidson & Kappel, LLC, 485 7th Avenue, 14th Floor, New York, NY, 10018, US

(73) Assignee: LUK LAMELLEN UND KUPPLUNGSBAU BETEILIGUNGS KG, Buehl (DE)

(21) Appl. No.: 12/462,011

(22) Filed: Jul. 28, 2009

(30) Foreign Application Priority Data
Jul. 30, 2008 (DE) 10 2008 035 518.6

(51) Int. Cl. G06F 9/455

(52) U.S. Cl. 717/104; 717/135

(57) ABSTRACT

A process for testing models to see whether or not these models satisfy the modeling standard.

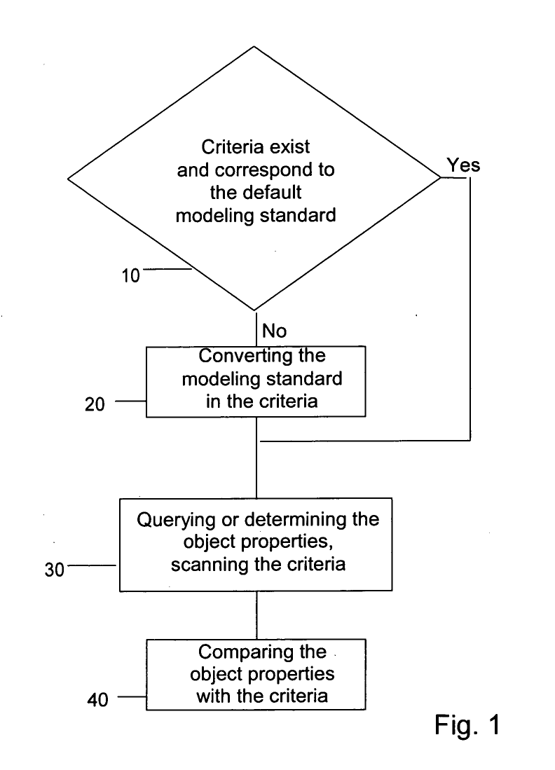

This claims the benefit of German Patent Application No. 10 2008 035 518.6 filed on Jul. 30, 2008, and hereby incorporated by reference herein.

The invention relates to a process with a computer program, a data carrier and a computer program product.

### BACKGROUND

In the domain of model-based software development, simulation models are reproduced, for instance, for control systems by block diagrams or by flow diagrams.

With the help of simulation models—within the scope of this publication, in short, called models—for instance, actuating systems and their control systems, as they are used, for instance, for the actuation of power windows, or transmissions or clutches, can still be simulated without having generated the code for the actual control of the real actuating system.

Tests of the simulated object—for instance, of the actuating system and the control as well—can be carried out by such a simulation.

For instance, settings of variable names and of associated data types can be made. Such settings can occur separately for each block of a block diagram.

Subsequently, the actual code is normally created in a programming language, for instance C, with the help of a code generator, and finally compiled, so that a program capable of running, for example, a vehicle control device, is obtained. Now, the real actuating system and control software tests can be conducted.

In the domain of model-based software development, modeling standards are used for guaranteeing the software quality. These modeling standards must be observed when creating each of the models from which the software will be generated later—for instance, as mentioned above, a control system available as a block diagram and compliance must be verified by means of subsequent testing. However, also the settings made for the code generator can be checked as well. The invention described here serves for testing whether or not the modeling standards are observed.

A modeling standard consists of several modeling guidelines—also called guidelines in short. The latter are normally at disposal in textual form, thus in the text form.

To date, compliance with the modeling standard is mainly ensured by means of manual review. In the course of doing this, the checklists are defined in advance; these are reviewed item-for-item and remarks are made, whether this item of the checklist was implemented in the respective model. Furthermore, there are programs that automatically check the modeling standard. Such programs, for instance, include “ModelAdvisor” by Mathworks Company, “Model Examiner” by MES Model Engineering Solutions Company and “mint”, by Ricardo Company. These programs contain test algorithms, by means of which the compliance with a predefined selection of guidelines of a generally recognized (e.g. MAAB “MathWorks Automotive Advisory Board”) modeling standard can be checked automatically. Moreover, these programs contain an interface that allows the integration of one's own test algorithms in the programs.

The manual testing of compliance with the modeling standard is very time-consuming, since a variety of block settings must be checked. In addition, this manner of testing is also very error-prone, since, owing to numerous setting possibilities, erroneous settings can be overseen quickly.

Still, experience has shown that company-specific modeling standards, which are tested manually, are frequently equivocal—so to speak are “softly” formulated. Accordingly, they are frequently interpreted differently and the quality of testing depends strongly on the respective tester and his understanding of the modeling guidelines.

The automated testing of the modeling standard according to the state of the art has the disadvantage that only predefined modeling standards can be tested. Company specific or project specific adjustments respectively and extensions can therefore not be tested with this program or special test algorithms must be programmed and then integrated in the corresponding programs. According to the state of the art—as soon as a guideline has changed—new testing algorithms must be programmed also for each individual case, which implicates a high demand of time and resources.

### SUMMARY OF THE INVENTION

The present invention relates to a process by means of which the testing of models can take place automatically, comfortably and in a short time, based on a company-specific or a project specific modeling standard.

The present invention provides a process in which a simulation model can be tested automatically, whether a company-specific or project-specific modeling standard has been observed, without a special test algorithm having to be programmed whenever change is made within the modeling standard; but rather, only a test algorithm should be created independently of the respectively current or desired modeling standard and be default by the user and a data record specifically for the desired, default modeling standard, in which the modeling standard is contained in the form of automatically testable criteria. If the modeling standard changes or a different one is desired, only the data record that contains the criteria must be adapted, the test algorithm do not need to be changed.

In accordance with the invention, it will first be verified whether the criteria that are formed by converting a textual modeling standard and that correspond to a default modeling standard are already at disposal. The default modeling standard can be default by the user.

In a further step, the simulation models from which the software will be generated later will be checked by means of a test algorithm, wherein, it will be verified whether the criteria are fulfilled. The result of the test will be disclosed to the user.

In accordance with the invention, the test algorithm remains unchanged when the modeling standard changes. The test algorithm remains unchanged independently of the change of the modeling standard.

Software is normally generated from the simulation model after successful testing.

If still no criteria that correspond to the default modeling standard exist, for instance, the criteria already formed from the latter—conversion of the textual modeling standard into criteria that now correspond to the default modeling standard takes place according to the invention.

A model can be a block diagram or a flow diagram. In addition, other graphical or non-graphical depictions of a model are possible.

A block diagram or a flow diagram is made of elements that within the scope of this document are designated as objects. A block diagram or a flow diagram comprises such objects.

A textual modeling standard comprises textual modeling guidelines.

In accordance with the invention, the criteria comprise testing criteria but can also comprise testing and restrictions criteria.

In accordance with the invention, the simulation model may be verified in such a manner that the object properties of the objects are read out or determined and finally compared for correspondence with the testing criteria. If a testing criterion is accompanied by restriction criteria, then the testing criterion is only applied to the very objects for which the restriction criterion applies.

In accordance with the invention, a computer program may be proposed with program code for executing the above-described process, when the program is executed on a computer. Such a computer program may be stored on a machine-readable carrier in accordance with the invention.

In accordance with the invention, also a data carrier with electronically readable control signals may be provided, which can work with a programmable computer system, so that the above-described process can be carried out.

In accordance with the invention, a computer program product may be proposed with program code for executing the above-described process, when the program is executed in a computer.

### BRIEF DESCRIPTION OF THE DRAWINGS

Further advantage and advantageous embodiments of the invention are objects of the following FIGURE as well as of their description.

The FIGURE shows a schematic of the process sequence according to the invention.

### DETAILED DESCRIPTION

The FIGURE depicts the schematic view of the process sequence according to the invention. In the process step 10 it is verified whether criteria are present and whether they correspond to the default modeling standard that shall find application. If this is not the case—there are no criteria or they do not correspond to the default modeling standard—then the criteria will be determined anew in the Conversion Step 20. On the contrary, if criteria that were won from the desired modeling standard exist, then the present criteria are used.

In the Process Step 30, the object properties of the model to be tested are queried or determined and the criteria, for instance, in the form of data records are read in.

In the Comparison Step 40, it is verified whether the object properties fulfill the criteria.

If the result of testing is that objects, for instance, of the block diagram do not satisfy the criteria then this will be displayed, so that the block diagram can be corrected. The result of the testing process is generally displayed, so that in the absence of fault also documentation for it, for instance, in connection with the release of the model, exists.

The process according to the invention is subdivided in principle in two steps.

In the first step, criteria for the textual modeling standard are formulated, whether the basis of the observation of the modeling standard can be tested in the model or rather in the block diagram building it. These criteria specify how one or several object properties should be set so that corresponding guidelines for the respective object would be observed. Under the term object, one thereby understands, for instance, the elements forming a block diagram or the elements out of which a flow diagram is comprised. Only object properties are possible in the process, whose current setting can be queried or determined automatically. Object properties can thereby be either direct properties or indirectly calculated properties of the respective object.

Since not all guidelines are valid for all objects, restriction criteria must still be defined in addition to the actual testing criteria, so that only the objects are tested, for which the guideline is also valid.

A criterion is formed out of a properties' name, which is specified by a properties value.

### EXAMPLE 1

Guideline: Sum blocks should use the “rectanglular” shape.
Restriction criterion: BlockType == Sum
Testing criterion: IconShape == rectangular

### EXAMPLE 2

Guideline: the signal flow in a model is from left to right (Execution: Feedback loop).
Restriction criterion: isFeedbackLoopComponent == false
Testing criterion: Orientation == right

In a further example, a file name can be used as a testing criterion for a certain BlockType or for a setting made for the code generator of the properties name, to which now the actual file name is assigned and whose presence is verified.

The models are normally present graphically, so that the restriction and testing criteria is not present directly in this form. In the background of the model, there are mostly object properties like “BlockType” for example. However, it is also possible that these properties are not directly present, but are first determined by means of a suitable program.

For instance, the models can be present as an ASCII-file, so that it would also be possible to scan them. Usually, however, API functions are at disposal, by means of which one obtains the properties of the objects.

These criteria are laid out once when introducing the modeling standard or when making changes to the modeling standard. Thus, the result from the textual modeling standard to be tested is a clear data record, which contains the exact object settings—that means that the settings of the object property must be set in order for the corresponding guidelines to be observed.

In the second step, it is verified by means of suitable methods, whether the defined testing criteria are observed in the models out of which the software will be generated later—for example the block diagrams. The methods in question are special test algorithms that can query the same object properties or objects, and that are contained in special software.

These test algorithms are but independent of the content of the guideline to be tested and on the one hand contain program components for reading or determining the object properties and, on the other hand, contain program components for comparison of the set object property with the specified object settings. When now all the settings in the model correspond to the specified settings, it is ensured that the modeling standard is observed in the respective model. Corresponding notification is provided through the process. If violations against the guidelines are detected, the user will also be informed about it.

Since an interpretation of the text of the modeling standard by means of a program would be faulty, such a data record will be created with the help of a program. The criteria for a guideline are compiled by the user by means of a special dialog.

A further advantage of this process is that after the creation of this data record is ensured, also all the standards are clearly formulated, since the compilation of this criteria leads to exact consideration of all guidelines and also—to some extent “soft”—formulated rules must be reworked. Therefore, the so-called “soft” guidelines and different understanding of guidelines are prevented from the start.

The process is divided in principle in two steps:

If required, one-time rewording of the textual modeling standard in verifiable criteria

Application of a method that contains a special test algorithm for testing the models consisting of objects—whether the objects and thus the model fulfils the criteria. In content, the method is thereby independent of the guidelines or the criteria to be verified.

The process described here serves for automated testing of the modeling standard within the scope of the model-based software development. It is essentially characterized in that in the first step criteria are defined from the textual modeling standard. These criteria specify how one or several object properties must be set so that corresponding guidelines for the respective object would be observed.

Based on these criteria, by means of suitable algorithms, a model that comprises the above-mentioned objects can then be automatically tested, whether all criteria and thus all corresponding guidelines can be observed. The test algorithm is in the process independent of the guideline to be verified, which means that, when a change or amendment of a guideline occurs, only the criteria catalog should be adapted and the actual test algorithm can be used further without changes.

### LIST OF REFERENCE SYMBOLS

10 Process Step

20 Conversion Step

30 Process Step

40 Comparison Step

What we claim is:

1. A process for testing a simulation model, whereby it is verified whether the simulation model fulfils a default modeling standard, wherein the process comprises the following steps:
verifying whether criteria already exist, the criteria being formed by converting a textual modeling standard that corresponds to the default modeling standard;
verifying the simulation model by a test algorithm, wherein the simulation model it is verified whether the criteria are fulfilled; and
outputting the results of the testing, wherein by changing the default modeling standard, the test algorithm remains unchanged.

2. The process according to claim 1 wherein software is generated from the simulation model.

3. The process according to claim 1 wherein conversion of a textual modeling standard occurs in the criteria.

4. The process according to claim 3 wherein upon changing the modeling standard, the criteria are adapted in that the conversion of a textual modeling standard occurs in the criteria.

5. The process according to claim 1 wherein a model is either a block diagram or a flow diagram.

6. The process according to claim 5 wherein the block diagram comprises objects.

7. The process according to claim 5 wherein the flow diagram comprises objects.

8. The process according to claim 1 wherein the textual modeling standard comprises textual modeling guidelines.

9. The process according to claim 1 wherein the criteria comprise testing criteria.

10. The process according to claim 1 wherein the criteria comprise test and restriction criteria.

11. The process according to claim 1 wherein the verification of the simulation model occurs in such a manner that object properties of objects are read out or are determined and compared with the testing criteria for correspondence.

12. A computer program with program code for executing the process according to claim 1 when the program is executed on a computer.

13. The computer program according to claim 12 wherein the program is stored on a machine-readable carrier.

14. A data carrier with electronically readable control signals, which can work together with a programmable computer system so that a process is executed according to claim 1.

15. A computer program product with program code for executing the process according to claim 1 wherein the program is executed in a computer.

16. A computer-usable medium having computer readable instructions stored thereon for execution by a processor to perform a method comprising the process as recited in claim 1.
